(19) United States
(12) Patent Application Publication
(10) Pub. No.: US 2026/0176406 A1
(43) Pub. Date: Jun. 25, 2026

(54) THERMOSET POLYURETHANE FOAM INCORPORATING DYNAMIC COVALENT ADAPTABLE NETWORKS

(71) Applicant: Ford Global Technologies, LLC, Dearborn, MI (US)

(72) Inventors: Xiaojiang Wang, Saline, MI (US); Ellen Cheng-chi Lee, Ann Arbor, MI (US); Seyedeh Raziyeh Mohammadi, LaSalle (CA); Thomas Andre, Saline, MI (US)

(73) Assignee: Ford Global Technologies, LLC, Dearborn, MI (US)

(21) Appl. No.: 18/987,726

(22) Filed: Dec. 19, 2024

(51) Int. Cl. C08G 18/32; C08G 18/38

(52) U.S. Cl. CPC C08G 18/3246; C08G 18/3275; C08G 18/3872; C08G 2110/0083

(57) ABSTRACT

A thermoset polyurethane foam has chemical dynamic covalent adaptable networks. The foam comprises a reaction product of a polyol mixture and an isocyanate mixture. The polyol mixture comprises a polyol and a dynamic cross-linking agent with a content between 0.1 to 70 wt. %. The dynamic cross-linking agent forms dynamic cross-linking bonds.

### FIELD

The present disclosure relates to polyurethane foams generally, and more particularly to thermoset polyurethane foams.

### BACKGROUND

The statements in this section merely provide background information related to the present disclosure and may not constitute prior art.

Polyurethane (PU) foams are utilized in a variety of automotive applications, as they can form lightweight, flexible, high-resilience, and rigid foams.

Conventional polyurethane foams are manufactured by reacting a polyol mixture with an isocyanate mixture. The polyol mixture reacts with the isocyanate mixture to form a thermoset polymer via two reactions. One is the gelling reaction between polyol and isocyanate forming a polyurethane bond; the other is the blowing reaction between water as a blowing agent and isocyanate forming carbon dioxide and a polyurea bond. Because of these permanent cross-linking bonds, polyurethane foams are strong and durable. However, the cross-linking bonds also mean the foam cannot be easily reprocessed.

Covalent adaptable networks (CANs) utilize dynamic chemical covalent bonds that undergo exchange reactions upon application of an external stimulus, typically heat or light. In absence of a stimulus, these materials behave as thermosets, showing high chemical resistance and dimensional stability. When the stimulus is applied, the dynamic bonds become activated, enabling the network to rearrange its topology on a molecular level. As a result, these materials undergo deformations, enabling reshaping and reprocessing.

PU foams containing CANs are being investigated as a replacement for conventional foams, which would allow for easier recyclability of thermoset PU foam waste. However, existing methods rely on the addition of catalysts during reprocessing, or the use of sulfurous compounds which can create issues with odor, stability, and durability during the life of the foam.

The present application addresses issues related to thermoset polyurethane foams.

### SUMMARY

This section provides a general summary of the disclosure and is not a comprehensive disclosure of its full scope or all of its features.

In one form, the present disclosure provides a thermoset polyurethane foam with chemical dynamic covalent adaptable networks. The foam comprises a reaction product of a polyol mixture and an isocyanate mixture. The polyol mixture comprises a polyol and a hindered amine with a content between 0.1 to 70 wt. % of the polyol mixture. The hindered amine forms dynamic cross-linking urea bonds.

In variations of this method, which may be implemented individually or in any combination: between 5% and 100% of the crosslinking sites in the foam are formed by dynamic crosslinking bonds; the hindered amine is an oligomer; the hindered amine is a monomer; the content of hindered amine is between 0.05 and 20.0 wt. % of the polyol mixture; the hindered amine is 4,4′-Trimethylenedipiperidine; and the hindered amine is diethanolamine.

The present disclosure further provides another thermoset polyurethane foam with chemical dynamic covalent adaptable networks. The foam comprises a reaction product of a polyol mixture and an isocyanate mixture. The polyol mixture comprises a polyol and a phenol with a content between 0.1 to 70 wt. % of the polyol mixture. The phenol forms dynamic cross-linking bonds.

In variations of this method, which may be implemented individually or in any combination: the polyol mixture further comprises one or more of a cell opener, a surfactant, a blowing agent, and a catalyst; the phenol is an additive; the phenol additive is solid at room temperature; the phenol additive is one or more of lignin, tannin, phenolic resin; the phenol additive content is between 0.1% to 40 wt. % of the polyol mixture; the phenol content is between 0.40 wt. % to 70 wt. % of the polyol mixture; the phenol is 4.4′-sulfonyldiphenol; the phenol content is between 1 and 10 wt. % of the polyol mixture; the phenol is one or more of gallic acid, resveratrol, quercetin, hydroquinone, curcumin, 4,4′-dihydroxybiphenyl, bisphenol, 4,4′-sulfonyldiphenol, 4-aminophenol, 2-hydroxybenzyl alcohol, and 4-hydroxybenzyl alcohol; and between 5% and 100% of the crosslinking sites in the foam are formed by dynamic crosslinking bonds.

In another form, the present disclosure provides yet another thermoset polyurethane foam with chemical dynamic covalent adaptable networks. The foam comprises a reaction product of a polyol mixture and an isocyanate mixture. The polyol mixture comprises a polyol, a phenol, and a hindered amine. The phenol and the hindered amine form dynamic cross-linking bonds.

In a variation of this method, between 5% and 100% of the crosslinking sites in the foam are formed by dynamic crosslinking bonds.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows dynamic bond exchanges for thermoset PU foam containing dynamic covalent adaptable networks (CANs);

FIG. 2 shows a chemical structure for several hindered amine compounds according to one aspect of the present disclosure;

FIG. 3 shows photographs of reprocessing results for several examples according to one aspect of the present disclosure;

FIG. 4 shows a chart of relaxation time for several examples according to one aspect of the present disclosure;

FIG. 5 shows photographs of reprocessing results for several examples according to one aspect of the present disclosure;

FIG. 6 shows a chemical structure for several mono-functional phenol compounds according to one aspect of the present disclosure;

FIG. 7 shows a chemical structure for several di-functional phenol compounds according to one aspect of the present disclosure;

FIG. 8 shows a chemical structure for several tri- and multi-functional phenol compounds according to one aspect of the present disclosure; and

FIG. 9 shows photographs of reprocessing results for several examples according to one aspect of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

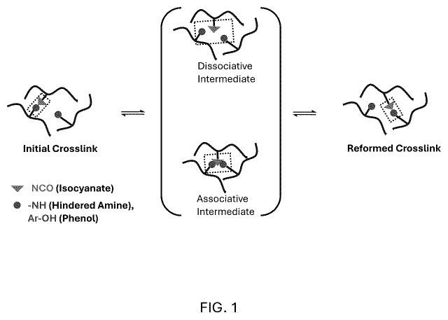

The present disclosure presents a thermoset polyurethane foam with a composition in which dynamic cross-linking agents create dynamic cross-linking chemical bonds. Together, the dynamic cross-linking bonds form a chemical dynamic covalent adaptable network in which the crosslink bonds can change and reform. As described above, the dynamic cross-linking bonds undergo exchange reactions when a stimulus is applied. When the stimulus is applied, the dynamic bonds become activated, enabling the network to rearrange its topology on a molecular level, as shown in FIG. 1. Therefore, as used herein, chemical dynamic cross-linking adaptable networks are polymer networks possessing reversible covalent cross-links with the capacity for adapting to an externally applied stimulus. In the present disclosure, the dynamic cross-linking agents in the thermoset polyurethane foam present a novel method of producing a chemical dynamic covalent adaptable network.

The thermoset polyurethane foam includes the reaction product of an isocyanates with a polyol mixture in which both gelling and blowing reactions occur. The polyol mixture includes at least one polyol and a dynamic cross-linking agent. The dynamic cross-linking agent includes at least one of a hindered amine and a phenol which will each be discussed in more detail below.

In one form, between 5% and 100% of the cross-linking sites in the foam are formed by dynamic cross-linking bonds.

In one form, the cross-linking agent is an additive to the polyol mixture. In another form, the cross-linking agent replaces a portion of the polyol in the polyol mixture. For example, up to 70% of the polyol could be replaced by a hindered amine or a phenol material. Replacement of polyol with hindered amine can increase the processability of foam to film but has limited reprocessability of film to film. Replacement of polyol with phenol can further increase the film-to-film reprocessability.

In one form, the polyol mixture also includes additives such as, but not limited to, a cell opener, a surfactant, a catalyst, and/or a blowing agent. Additionally, the polyol mixture in some forms also contains a traditional cross-linking agent such as diethanolamine or triethanolamine. Traditional cross-linking agents are utilized in foam applications to build firmness, increase catalytic activity, strengthen the crosslinked network, and control flexural and other properties of the foam.

As used herein, ‘isocyanate” as in the isocyanate mixture, includes diisocyanates such as, for example, aromatic diisocyanates, toluene diisocyanates (“TDI”), and methylene diphenyl diisocyanates (“MDI”), as well as polyisocyanates, and mixtures thereof. Non-limiting examples of isocyanates include methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), tolidine diisocyanate (TODI), and combinations thereof. It is contemplated isocyanates may include polymeric materials.

The polyol includes at least one of petroleum-based polyols, bio-based polyols, and CO2-polyols, as well as mixtures thereof.

As used herein, “petroleum-based polyols” (hereafter “petro-polyol”) are polyether polyols which can be used in the practice of the present disclosure and are well known and widely available commercially. Such polyols are generally at least about 80% by weight or more of a composition or blend of compositions directly or indirectly obtained from a non-renewable resource such as crude oil. Non-limiting examples of the polyether polyols include polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols, poly-1,4-tetramethylene and polyoxyethylene glycols, and random and block copolymer glycols prepared from blends or sequential addition of two or more alkylene oxides. The mechanical properties of the resultant polyurethane foam may dictate the consistency of the polyol. More specifically, higher molecular weight polyols generally form more flexible polyurethanes, whereas lower molecular weight polyols generally form more rigid polyurethanes.

As used herein, “bio-based polyols” refer to polyols generally at least about 80% by weight or more of a composition or blend of compositions directly or indirectly obtained from a natural (e.g., animal or plant-based) oil. In other embodiments, the polyols are generally at least about 85% by weight, at least 90% by weight, and/or at least 95% by weight or more of a composition or blend of compositions directly or indirectly obtained from a natural oil. Natural oil, as used herein, includes but is not limited to vegetable oils, animal fats, algae oils tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, and castor oil. Representative non-limiting examples of animal fats include lard, tallow, poultry fat, yellow grease, and fish oil, as well as polyols made from the bio-based diols 1,3-propanediol (PDO) and 1,4-butanediol (BDO) and diacids, including succinic acid and larger acids such as Elevance's Inherent C18 octadecanedioic acid (ODDA). Representative non-limiting examples of algae oils include microalgae, such as Nannochloropsis, Spirulina, Chlorella; algae, such as red algae-Rhodophyta, red algae, Pithophora oedegonia, green algae, among others, and combinations thereof.

As used herein, carbon dioxide-based polyols are poly(ether carbonate) polyols (hereafter “CO2-polyol”). Non-limiting examples of CO2-polyols include CARDYON® LC-05, available from Covestro Deutschland AG.

Cell openers are used to prepare foam structures that have predominantly open cells, which gives it a larger value of air permeability and include water-soluble emulsifiers.

Surfactants are useful for cell nucleation and cell opening in foam applications and offer foam stabilization. One nonlimiting example of a surfactant is TEGOSTAB® B 4690, available from Evonik Degussa, but it is contemplated other nonionic surfactants may be suitable for preparing the polyurethane foams disclosed herein.

Catalysts enhance the processing characteristics and physical properties of polyurethane foams by promoting the basic chemical reactions between polyol and isocyanate, reactions between water and isocyanate, and reactions to trimerize isocyanates. Catalysts may be selected according to the needs of a particular application, for example, to improve the polyether foaming process of a wide variety of foams, including high-density unfilled foam, filled foam, high load-bearing flexible foam, low-density foam, and high resilience molded foam. Other catalysts may be selected to delay the foam-forming reaction process, which can result in more open foam structures. Suitable catalysts according to the present disclosure are dibutyltin dilaurate and diluted amine ethers. Tertiary amines may be desirable as catalysts when water is present in the polyol isocyanate reaction mixture, as it catalyzes the isocyanate to react with water to form urea linkages with urethane.

Blowing agents assist in preparing foam, and water is most commonly used as a blowing agent. Other potential blowing agents include fluorocarbons, hydrochlorocarbons, chlorofluorocarbons, hydrofluorocarbons, and/or hydrocarbons. It is also contemplated that gas may be added directly to the polyol isocyanate reaction mixture to form the foam. The particular blowing agent needed is dependent on the foam properties desired for a particular application as well as the selected isocyanate and polyol mixture. The blowing agents disclosed are merely exemplary and other blowing agents or gases may be utilized within the scope of the present disclosure.

Other optional additives include buffers, dendritic macromolecules, inorganic particulates, other types of polyols not listed herein, polyisocyanates, i.e. retardants, deodorants, colorants, chain extenders, fillers, combinations thereof, and other additives known to those familiar with the technology as specific application requirements dictate.

### Hindered Amine

As used herein, the “hindered amines” are compounds containing one or more hindered amine functional groups in which the nitrogen atom of an amine group is partially shielded by neighboring groups so that larger molecules cannot easily approach and react with the nitrogen. In the polyurethane foam, the hindered amine functional groups form dynamic cross-linking hindered urea bonds (HUB) at the cross-linking sites. The dynamic cross-linking HUB bonds are a specific type of dynamic cross-linking bond formed by the hindered amine functional groups.

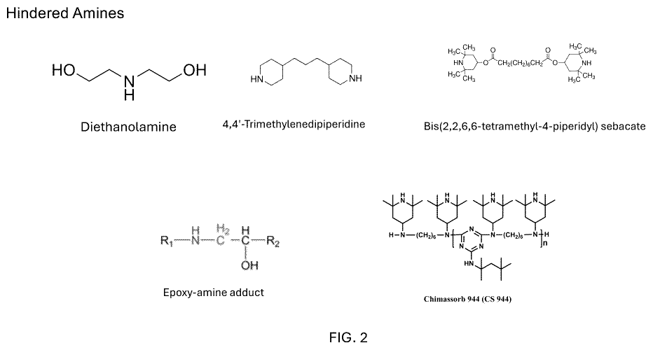

FIG. 2 shows the chemical structure of several hindered amines within the scope of the present disclosure. However, these are merely exemplary, and the possible materials are not limited to those explicitly listed. In one form, the hindered amine includes at least one of 4,4-trimethylenedipiperidine, diethanolamine, Bis(2,2,6,6-tetramethyl-4-piperidyl) sebacate, and epoxy-amine adducts. The hindered amine is either an oligomer or a monomer. In one form, the hindered amine is an oligomer, and its content is between 0.1 and 70 wt. % of the polyol mixture. In one form, the hindered amine is a monomer, and its content is between 0.05 and 20.0 wt. % of the polyol mixture. The neighboring group and molecular weight of the hindered amine affect the hindered amine selection and the hindered amine content of the polyol mixture. The larger the neighboring group, the slower the reactivity of hindered amine towards isocyanates, and the larger content of hindered amine is required to replace polyol. The higher the molecular weight of the hindered amine, the larger content of hindered amine is required to replace polyol.

Table 1 below shows three example compositions used to compare reprocessability of polyurethane foams containing a hindered amine according to the present disclosure with a ‘control’ foam without the dynamic cross-linking agent.

TABLE 1
Examples 1-3: 4,4′-Trimethylenedipiperidine

| | | | Exp 1 | Exp 2 | Exp 3 |
|---|---|---|---|---|---|
| | Chemical Name | Chemical Type | 4701-Control | 0.5% HUB | 2% HUB |
| Part B | Voranol 4701 (g) | Polyol | 182.41 | 181.5 | 178.76 |
| | 4,4′-Trimethylene- | Dynamic Cross- | 0 | 0.91 | 3.65 |
| | dipiperidine (g) | linking Agent | | | |
| | Lumulse POE 26 (g) | Cell Opener | 1.82 | 1.82 | 1.82 |
| | Tegostab B 4690 (g) | Surfactant | 0.91 | 0.91 | 0.91 |
| | Added Water (g) | Blowing Agent | 5.47 | 5.47 | 5.47 |
| | Diethanolamine | Partially Dynamic | 2.74 | 2.74 | 2.74 |
| | LF 85% (g) | Cross-linking Agent | | | |
| | Niax A300 (g) | Catalyst | 1.09 | 1.09 | 1.09 |
| | Niax Al (g) | Catalyst | 0.55 | 0.55 | 0.55 |
| Part A | Rubinate 7304 (g) | Isocyanate | 115.53 | 116.65 | 120.03 |

The hindered amine is 4,4-trimethylenedipiperidine. Diethanolamine provides a small secondary cross-linking effect. Example 1 is a control foam in which the 4,4-trimethylenedipiperidine content is 0%. Examples 2 and 3 are foams containing 0.5 wt. % (0.91 g) and 2.0 wt. % (3.65 g) of the hindered amine respectively.

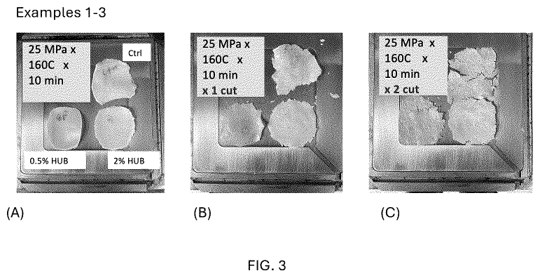

As shown in FIG. 3, each of Examples 1-3 foams (labeled as control, HUB 0.5% and 2.0% respectively) was compressed into a polyurethane film by heating to 160° C. and pressing with 25 MPa of pressure for 10 minutes (see FIG. 3(A)). Subsequently, the film was cut into pieces and reprocessed into film again (see FIG. 3(B)). Finally, the film-to-film reprocessing was repeated as shown in FIG. 3(C). It can be seen that with each reprocessing, the material becomes more brittle. However, the examples containing 4,4′-trimethylenedipiperidine remain workable for longer than the control sample.

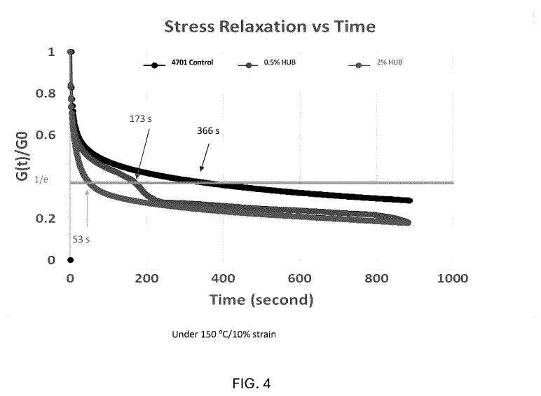

FIG. 4 shows the relaxation time for each of Examples 1-3 measured on the film made via the first compression molding process (foam-to-film). Examples 2 and 3 containing 4,4′-trimethylenedipiperidine have a reduced film relaxation time compared to the control of Example 1. A shorter relaxation time is an indication that reprocessing will be more effective. Therefore, addition of 4,4′-Trimethylenedipiperidine aids in the foam-to-film compression molding process. Further, as the 4,4′-trimethylenedipiperidine increases, the relaxation time decreases further.

Table 2 below shows two further example compositions in which the hindered amine is diethanolamine.

TABLE 2
Examples (4-5): Diethanolamine

| | | | Equivalent | Exp 4 | |
|---|---|---|---|---|---|
| | | | Weight | 2090- | Exp 5 |
| | Chemical Name | Chemical Type | (g/mole) | Control | DEA-1% |
| Part B | Pluracol 2090 (g) | Polyol | 2015.81 | 48.4 | 24.2 |
| | UBE diol (g) | Polyol | 1000 | 0 | 24.2 |
| | Multranol 9199 (g) | Cell Opener | 1464.75 | 1.5 | 1.5 |
| | Tegostab B 4690 (g) | Surfactant | 1335.7 | 0.5 | 0.5 |
| | Added Water (g) | Blowing Agent | 9 | 1.72 | 1.72 |
| | Diethanolamine | Dynamic Cross- | 52.57 | 0.5 | 1 |
| | LF 85% (g) | linking Agent | | | |
| | Dabco 33LV (g) | Catalyst | 100.2 | 0.24 | 0.24 |
| | Toyocat ET (g) | Catalyst | 233.7 | 0.12 | 0.12 |
| Part A | Suprasec 7007 (g) | Isocyanate | 141.89 | 21.93 | 32.27 |

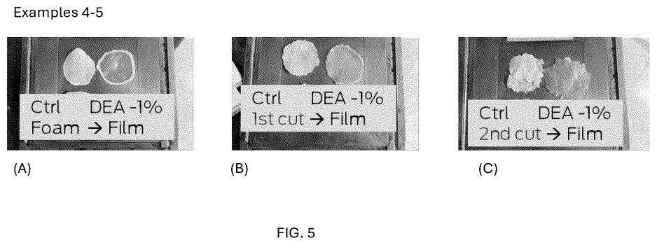

As with Examples 1-3 above, Examples 4 and 5 were also processed from a foam to a film (FIG. 5A), and then film to film (FIG. 5B). Example 5 (FIG. 5C) shows more cohesion after two reprocessing steps than control of Example 4.

### Phenol

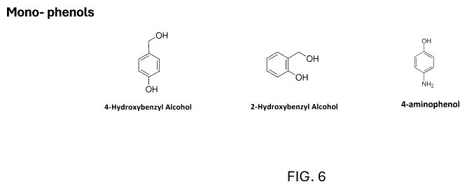

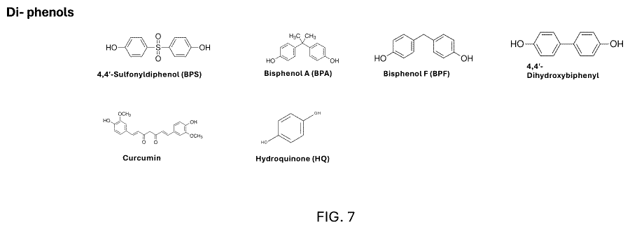

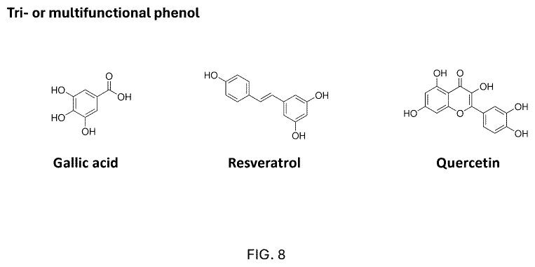

As used herein, a “phenol” is a compound that contains a six-membered aromatic ring, bonded directly to a functional hydroxyl group (—OH). The definition includes mono-, di-, tri- or multifunctional phenols and mixtures thereof. In various forms, the phenol, for example, is a mono-phenol such as 4-hydroxybenzyl alcohol (4-HBA), 2-hydroxybenzyl alcohol (2-HBA), or aminophenol; a di-phenol such as bisphenol, 3-methylcatechol, dihydroxybiphenyl, or hydroquinone; or a tri- or multifunctional phenol such gallic acid, quercetin, resveratrol, and lignin. FIGS. 6-8 show the chemical structure of several of these phenols; however, these are merely exemplary, and the possible phenols are not limited to those explicitly listed. In one form, the phenol is one or more of gallic acid, resveratrol, quercetin, hydroquinone, curcumin, 4,4′-dihydroxybiphenyl, bisphenol, 4,4′-sulfonyldiphenol, 4-aminophenol, 2-hydroxybenzyl alcohol, and 4-hydroxybenzyl alcohol. Reactivity, efficiency, and toxicity of the phenol compound guide its selection. The existence of electron withdrawing groups on the phenol aromatic ring favors the phenol reactivity with aromatic isocyanate and provides more efficient dynamic covalent adaptive network. Low toxicity phenols are favored when phenol a replacement for the polyol.

In one form, the phenol content is between 0.1 and 70 wt. % of the polyol mixture.

In one form, the phenol is an additive. In one form, the phenol additive forms 0.1-40.0 wt. % of the polyol mixture. In one variation on this form, the phenol additive is solid at room temperature. Compared with liquid phenol, solid phenols have lower reactivity towards isocyanate and less effect on the foam forming property. In one form, the phenol additive is one or more of lignin, tannin, and phenolic resin. Lignin and Tannin are bio phenols and have low toxicity. Phenolic resin is a widely available synthetic resin.

In one form, the phenol is 4.4′-sulfonyldiphenol and the phenol content is between 1 and 10 wt. % of the polyol mixture.

Table 3 below shows two further example compositions containing a phenol-4,4′-sulfonyldiphenol (BPS). Example 1 is used as a control composition as in Table 1.

TABLE 3
Examples (6-7): 4.4′-sulfonyldiphenol

| | | | Exp 1 | Exp 6 | Exp 7 |
|---|---|---|---|---|---|
| | Chemical Name | Chemical Type | 4701-Control | 5% BPS | 10% BPS |
| Part B | Vornanol 4701 (g) | Polyol | 182.41 | 173.29 | 164.17 |
| | 4.4′-sulfonyldiphenol | Dynamic Cross- | 0 | 9.12 | 18.24 |
| | (BPS) (g) | linking Agent | | | |
| | Lumulse POE 26 (g) | Cell Opener | 1.82 | 1.82 | 1.82 |
| | Tegostab B 4690 (g) | Surfactant | 0.91 | 0.91 | 0.91 |
| | Added Water (g) | Blowing Agent | 5.47 | 5.47 | 5.47 |
| | Diethanolamine | Partially dynamic | 2.74 | 2.74 | 2.74 |
| | LF 85% (g) | Cross-linking Agent | | | |
| | Niax A300 (g) | Catalyst | 1.09 | 1.09 | 1.09 |
| | Niax A1 (g) | Catalyst | 0.55 | 0.55 | 0.55 |
| Part A | Rubinate 7304 (g) | Isocyanate | 115.53 | 135.16 | 154.79 |

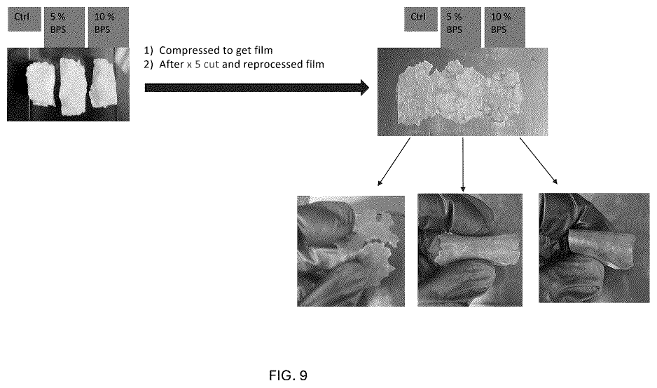

Examples 1, 6, and 7 were also processed from a foam to a film, and then film to film. FIG. 9 shows the results after five film-to-film reprocessing steps. Examples 6 and 7 demonstrate more flexibility after five reprocessing steps than control of Example 1.

In another form of the present disclosure, the polyol mixture may include both a phenol and a hindered amine. In one form, a phenol is utilized to replace a portion of the polyol while a hindered amine is added as an additional cross-linking agent. Alternatively, both a smaller amount of each a hindered amine and a phenol are included as additives. As in other forms described above, the hindered amine and the phenol form dynamic cross-linking bonds to form a covalent adaptable network. In one form, between 5% and 100% of the cross-linking sites in the foam are formed by dynamic cross-linking bonds.

The foams disclosed herein may be used in various applications where it is desirable to use foams, e.g., the automotive industry, including by way of example, the furniture industry, marine transportation industry. Further, the foams disclosed herein may be used in various automotive applications and for vehicle components, including but not limited to seat backs, arm rests, seat cushions, headliner applications, head rests, engine covers, oil pump covers, air conditioning compression covers, fuel covers, and under the hood covers, among others. Further, once reprocessed, films and molded components may also be used in various applications.

It should also be understood that the composition of the foam includes all incremental values between the minimum content of dynamic cross-linking agent and maximum content of dynamic cross-linking agent values listed above. That is, a minimum content of dynamic cross-linking agent can range from the minimum value to the maximum value described. Likewise, the maximum content of dynamic cross-linking agent can range from the maximum value shown to the minimum value described. For example, the minimum hindered amine content can be 0.05, 0.06, 0.07, 0.08, 0.09, 0.1, 0.2, 0.3, 0.4, 0.5, 0.6, 0.7, 0.8, 0.9, 1.0, 2, 3, 4, 5, 6, 7, 8, 9, 10, 20, 30, 40, 50, 60, or 69.99, and any value between these incremental values.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A thermoset polyurethane foam with chemical dynamic covalent adaptable networks, the thermoset polyurethane foam comprising:
a reaction product of a polyol mixture and an isocyanate mixture,
wherein the polyol mixture comprises a polyol and a hindered amine, the hindered amine having a content between 0.1 to 70 wt. % of the polyol mixture, and the hindered amine forming dynamic cross-linking hindered urea bonds.

2. The thermoset polyurethane foam of claim 1, wherein between 5% and 100% of cross-linking sites in the thermoset polyurethane foam are formed by dynamic cross-linking hindered urea bonds.

3. The thermoset polyurethane foam of claim 1, wherein the hindered amine is an oligomer.

4. The thermoset polyurethane foam of claim 1, wherein the hindered amine is a monomer.

5. The thermoset polyurethane foam of claim 4, wherein the content of hindered amine is between 0.05 and 20.0 wt. % of the polyol mixture.

6. The thermoset polyurethane foam of claim 4, wherein the hindered amine is 4,4′-Trimethylenedipiperidine.

7. The thermoset polyurethane foam of claim 4, wherein the hindered amine is diethanolamine.

8. A thermoset polyurethane foam with chemical dynamic covalent adaptable networks, the thermoset polyurethane foam comprising:
a reaction product of a polyol mixture and an isocyanate mixture,
wherein the polyol mixture comprises a polyol and a phenol,
the phenol having a content between 0.1 to 70 wt. % of the polyol mixture, and
the phenol forming dynamic cross-linking bonds.

9. The thermoset polyurethane foam of claim 8, further comprising one or more of a cell opener, a surfactant, a blowing agent, and a catalyst.

10. The thermoset polyurethane foam of claim 8, wherein the phenol is an additive.

11. The thermoset polyurethane foam of claim 10, wherein the phenol additive is solid at room temperature.

12. The thermoset polyurethane foam of claim 10, wherein the phenol additive is one or more of lignin, tannin, phenolic resin.

13. The thermoset polyurethane foam of claim 10, wherein the phenol additive is between 0.1 wt. % and 40 wt. % of the polyol mixture.

14. The thermoset polyurethane foam of claim 8, wherein the phenol is between 40 wt. % and 70 wt. % of the polyol mixture.

15. The thermoset polyurethane foam of claim 8, wherein the phenol is 4.4′-sulfonyldiphenol.

16. The thermoset polyurethane foam of claim 15, wherein the phenol content is between 1 and 10 wt. % of the polyol mixture.

17. The thermoset polyurethane foam of claim 8, wherein the phenol is one or more of gallic acid, resveratrol, quercetin, hydroquinone, curcumin, 4,4′-dihydroxybiphenyl, bisphenol, 4,4′-sulfonyldiphenol, 4-aminophenol, 2-hydroxybenzyl alcohol, and 4-hydroxybenzyl alcohol.

18. The thermoset polyurethane foam of claim 17, wherein between 5% and 100% of cross-linking sites in the thermoset polyurethane foam are formed by dynamic cross-linking bonds.

19. A thermoset polyurethane foam with chemical dynamic covalent adaptable networks, the thermoset polyurethane foam comprising
a reaction product of a polyol mixture and an isocyanate mixture,
wherein the polyol mixture comprises a polyol, a phenol, and a hindered amine, the phenol and the hindered amine forming dynamic cross-linking bonds.

20. The thermoset polyurethane foam of claim 19, wherein between 5% and 100% of cross-linking sites in the thermoset polyurethane foam are formed by the dynamic cross-linking bonds.
